(19) United States
(12) Patent Application Publication
(10) Pub. No.: US 2025/0042054 A1
(43) Pub. Date: Feb. 6, 2025

(54) Product Cutting System

(71) Applicants: Tyco Electronics (Zhuhai) Ltd, Zhuhai (CN); TE Connectivity Solutions GmbH, Schaffhausen (CH); Tyco Electronics (Shanghai) Co., Ltd., Shanghai (CN)

(72) Inventors: Lei (Alex) Zhou, Shanghai (CN); Wei Zheng, Zhuhai (CN); Hao Li, Zhuhai (CN); Dandan (Emily) Zhang, Shanghai (CN); Roberto Francisco-Yi Lu, Bellevue, WA (US); Ming (Micky) Jiang, Zhuhai (CN); Liqing (Mary) Ma, Zhuhai (CN)

(73) Assignees: Tyco Electronics (Zhuhai) Ltd, Zhuhai (CN); TE Connectivity Solutions GmbH, Schaffhausen (CH); Tyco Electronics (Shanghai) Co., Ltd., Shanghai (CN)

(21) Appl. No.: 18/792,145

(22) Filed: Aug. 1, 2024

(30) Foreign Application Priority Data
Aug. 4, 2023 (CN) 202310981120.3

(51) Int. Cl. B26D 7/06; B26D 5/00; B26D 7/00

(52) U.S. Cl. CPC B26D 7/0625; B26D 5/00; B26D 2007/0012

(57) ABSTRACT

A product cutting system includes a cutting device disposed at a cutting station for cutting a product and a conveying device transporting the product to be cut to the cutting station. The cutting device is separate from the conveying device and can cooperate with a plurality of different conveying devices to cut a plurality of different products.

### CROSS-REFERENCE TO RELATED APPLICATION

This application claims the benefit of the filing date under 35 U.S.C. § 119(a)-(d) of Chinese Patent Application No. 202310981120.3, filed on Aug. 4, 2023.

### FIELD OF THE INVENTION

The present invention relates to a product cutting system, in particular to a product cutting system capable of cutting different products.

### BACKGROUND OF THE INVENTION

A product cutting system typically includes a cutting module and a conveying module. The cutting module has a cutting die for cutting products, and the conveying module usually has a conveying channel for conveying products. The cutting module and the conveying module are usually fixed to the same installation frame, which prevents the conveying module from being replaced. Because the conveying module cannot be replaced and can only transport one type of product, the product cutting system can only cut one type of product, which limits the application scope of the product cutting system.

### SUMMARY OF THE INVENTION

A product cutting system includes a cutting device disposed at a cutting station for cutting a product and a conveying device transporting the product to be cut to the cutting station. The cutting device is separate from the conveying device and can cooperate with a plurality of different conveying devices to cut a plurality of different products.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a product cutting system according to an exemplary embodiment of the present invention;

FIG. 2 shows an illustrative local enlarged view of a product cutting system according to an exemplary embodiment of the present invention;

FIG. 3 shows an illustrative perspective view of a cutting device of a product cutting system according to an exemplary embodiment of the present invention;

FIG. 4 shows an illustrative perspective view of the upper part of the cutting device of a product cutting system according to an exemplary embodiment of the present invention; and

FIG. 5 shows an illustrative perspective view of the lower part of the cutting device of a product cutting system according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

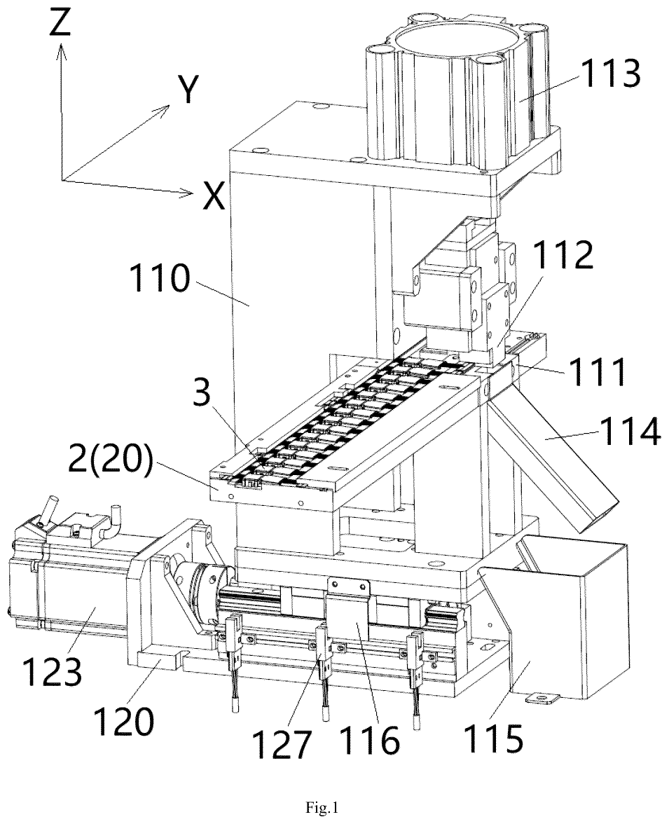

As shown in FIGS. 1 to 5, in an exemplary embodiment of the present invention, a product cutting system is disclosed. The cutting system includes a cutting device 1 and a conveying device 2. The cutting device 1 is set at the cutting station for cutting product 3. The conveying device 2 is used to transport the product 3 to be cut to the cutting station. The cutting device 1 is separated from the conveying device 2 and can cooperate with different conveying devices 2 to cut different products 3.

As shown in FIG. 1, in the illustrated embodiments, the cutting device 1 includes an installation frame 110, a pair of cutting dies 111, 112, and a first driving device 113. The pair of cutting dies 111 and 112 are installed on the installation frame 110 and can be opened and closed in a vertical direction Z for cutting the product 3. The first driving device 113 is installed on the installation frame 110 to drive the pair of cutting dies 111 and 112 to open and close.

As shown in FIG. 1, in the illustrated embodiments, the conveying device 2 includes a conveying channel 20, which is used to guide the product 3 to be transported along a predetermined path to the cutting station and other processing stations downstream of the cutting station. The conveying channel 20 is separated from the installation frame 110, allowing for the transportation of different products 3 to the cutting station by replacing different conveying channels 20.

As shown in FIGS. 1 to 4, in the illustrated embodiments, the pair of cutting dies 111 and 112 include a lower cutting die 111 and an upper cutting die 112. The lower cutting die 111 is fixed on the installation frame 110. The upper cutting die 112 can be movably installed on the installation frame 110. The conveying channel 20 has a matching notch suitable for matching with the lower cutting die 111. The lower cutting die 111 is matched into the matching notch of the conveying channel 20, allowing the product 3 to be transported to the top surface of the lower cutting die 111.

As shown in FIGS. 1, 3, and 4, in the illustrated embodiments, the first driving device 113 is connected to the upper cutting die 112, which is used to drive the upper cutting die 112 to move in the vertical direction Z, so as to cut the product 3 conveyed to the top surface of the lower cutting die 111. In an embodiment, the product cutting system further includes a first control device for controlling the output force and output speed of the first drive device 113 to ensure that the upper cutting die 112 can cut the product 3 with a predetermined cutting force and a predetermined cutting speed.

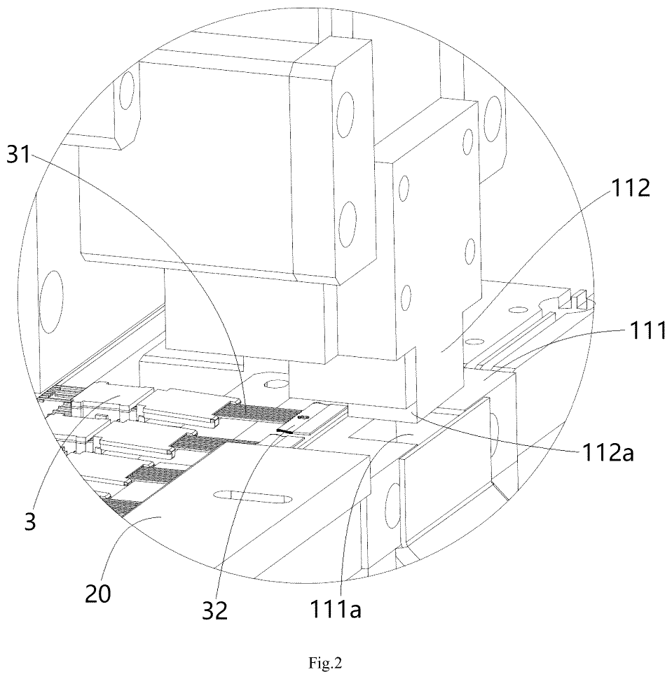

As shown in FIG. 2, in the illustrated embodiments, a slot hole 111a is formed in and vertically passes through the lower cutting die 111, and the upper cutting die 112 has a protrusion 112a suitable for matching with the slot hole 111a. The edges of the slot hole 111a and the protrusion 112a form the cutting edges for cutting the product 3. In the illustrated embodiments, when the portion to be cut of product 3 is moved and positioned in the slot hole 111a of the lower cutting die 111, the protrusion 112a of the upper cutting die 112 is inserted into the slot hole 111a of the lower cutting die 111 to cut off the portion to be cut of product 3.

As shown in FIGS. 1, 3, and 4, in the illustrated embodiments, the product cutting system further comprises a waste channel 114 and a waste recycling bin 115. The inlet of the waste channel 114 is connected to the outlet of the slot hole 111a of the lower cutting die 111, which is used to receive the waste generated during the cutting of product 3. The waste recycling bin 115 is connected to the outlet of the waste channel 114 and is used to receive the waste discharged from the waste channel 114. The waste channel 114 and the waste recycling bin 115 are fixed to the installation frame 110.

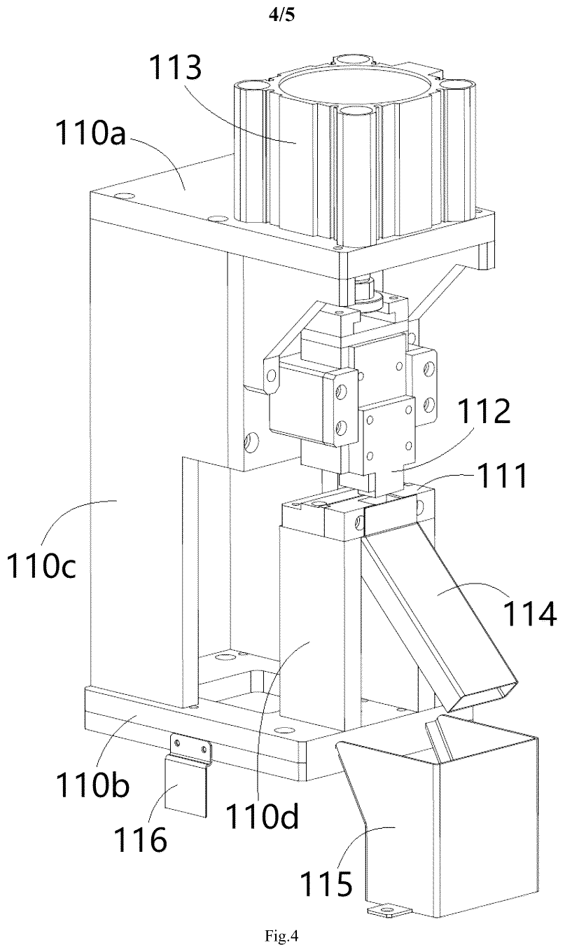

As shown in FIG. 4, in the illustrated embodiments, the installation frame 110 includes a support body 110c, a top plate 110a, a bottom plate 110b, and a support plate 110d. The support body 110c extends to a predetermined height along the vertical direction Z. The top plate 110a is fixed to the top of the support body 110c. The bottom plate 110b is fixed to the bottom of the support body 110c. The support plate 110d is fixed to the top surface of the bottom plate 110b. The first driving device 113 is installed on the top plate 110a, the upper cutting die 112 is movably installed on the support body 110c, the lower cutting die 111 is fixed on the support plate 110d, and the waste channel 114 and waste recycling box 115 are respectively fixed on the support plate 110d and the bottom plate 110b.

As shown in FIGS. 1, 3, and 5, in the illustrated embodiments, the product cutting system further comprises a base 120, which is used to support the installation frame 110. The installation frame 110 is movably mounted on the base 120 and can be moved along a first horizontal direction X. The conveying device 2 transports the product 3 along a second horizontal direction Y perpendicular to the first horizontal direction X.

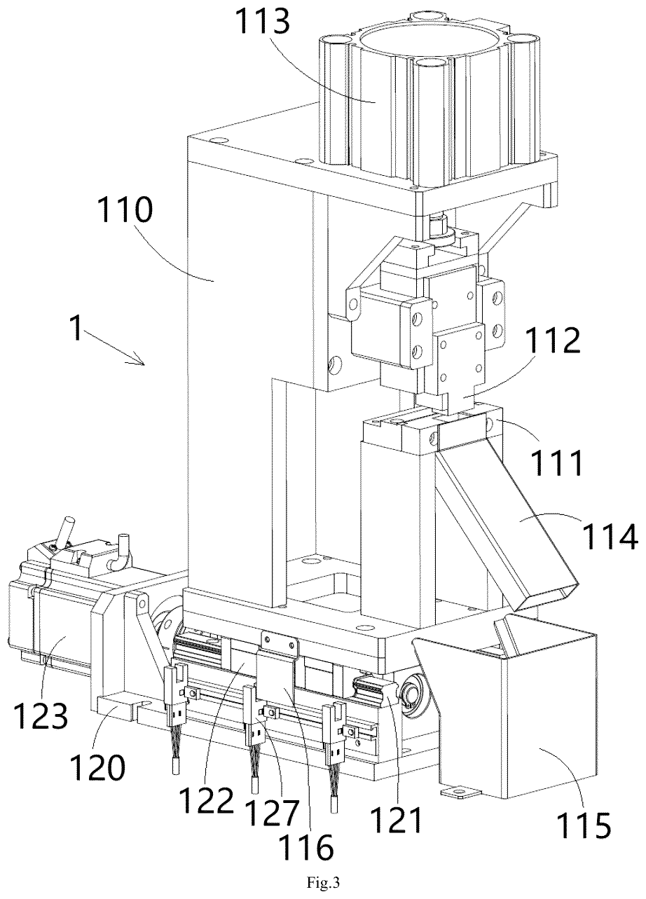

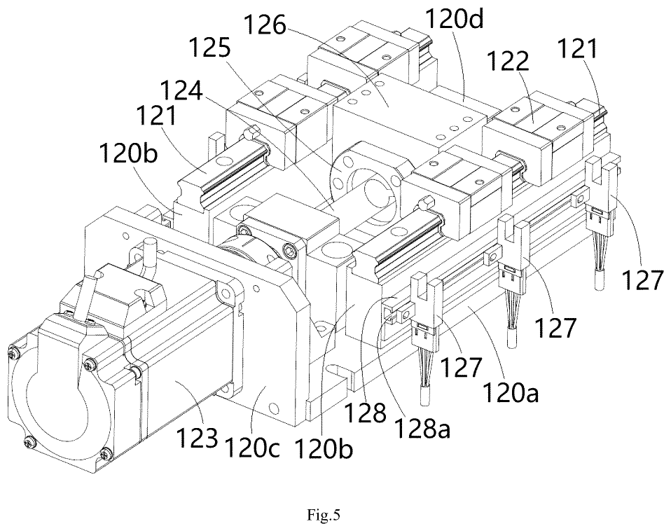

As shown in FIGS. 3 and 5, in the illustrated embodiments, the product cutting system further comprises a guide rail 121 and a slider 122. The guide rail 121 is fixed on the base 120 and extends along the first horizontal direction X. The slider 122 is slidably installed on the guide rail 121 to be able to slide along the guide rail 121. The bottom of the installation frame 110 is connected to the slider 122 to move along the guide rail 121 together with the slider 122.

In the illustrated embodiments, the product cutting system further includes a second driving device, which is installed on the base 120 to drive the installation frame 110 to move along the first horizontal direction X, so as to move the pair of cutting dies 111 and 112 to a predetermined cutting position.

As shown in FIGS. 1, 3, and 5, the second driving device includes a lead screw 124, a nut 125, a driving block 126, and a servo motor 123. The two ends of the lead screw 124 are rotatably installed on the base 120. The nut 125 is threaded to the lead screw 124. The drive block 126 is fixed to the nut 125. The servo motor 123 is installed on the base 120, and the axis of the lead screw 124 extends along the first horizontal direction X. The servo motor 123 is connected to one end of the lead screw 124 to drive it to rotate around its axis. The drive block 126 is connected to the bottom of the installation frame 110. When the lead screw 124 is rotated, the nut 125 and the drive block 126 are moved together along the axial direction of the lead screw 124 to drive the installation frame 110 to move in the first horizontal direction X.

In the illustrated embodiments, the product cutting system further comprises a second control device and a position sensor 127, shown in FIGS. 1, 3, and 5. The second control device is used to control the second driving device. The position sensor 127 is installed on base 120 to detect the position of the pair of cutting dies 111 and 112. The second control device controls the second driving device based on the position detected by the position sensor 127 to move the pair of cutting dies 111 and 112 to the predetermined cutting position. In the illustrated embodiments, the position sensor 127 is a trigger switch. When the pair of cutting dies 111 and 112 are moved to the predetermined cutting position, the position sensor 127 is triggered.

In the illustrated embodiments, the product cutting system comprises multiple position sensors 127, which are spaced in the first horizontal direction X and correspond to multiple predetermined cutting positions.

As shown in FIGS. 1, 3, and 4, in the illustrated embodiments, the product cutting system further includes a triggering member 116, which is fixed to the bottom of the installation frame 110 to move together with the installation frame 110. When the pair of cutting dies 111 and 112 are moved to the predetermined cutting position, the triggering member 116 is moved to the predetermined triggering position and triggers the corresponding position sensor 127.

As shown in FIG. 5, in the illustrated embodiments, the product cutting system includes a sliding slot member 128 and a connecting member. The sliding slot member 128 is fixed to the base 120 and has a sliding slot 128a extending along the first horizontal direction X. The connecting member is slidably installed in the sliding slot 128a of the sliding slot member 128 and connected to the position sensor 127. The position sensor 127 can be moved along the sliding slot 128a with the connecting member, so that the position of the position sensor 127 can be adjusted to be suitable for different products to be cut. Due to the different cutting positions of different products 3, it is necessary to adjust the position of position sensor 127 according to different products 3, so that the position of position sensor 127 corresponds to the cutting positions of different products 3.

As shown in FIG. 5, the base 120 includes a base plate 120a, a strip body 120b, an end plate 120c, and a pair of support blocks 120d. The strip body 120b is fixed on the top surface of the base plate 120a. The end plate 120c is fixed to one end of the base plate 120a. The pair of support blocks 120d are fixed on the top surface of the base plate 120a. The servo motor 123 is fixed to the end plate 120c, and the two ends of the lead screw 124 are respectively rotatably installed on the pair of support blocks 120d. The guide rail 121 and the sliding slot 128 are respectively fixed to the top and side surfaces of the strip body 120b.

As shown in FIGS. 1 and 2, in the illustrated embodiment, the cut product 3 can be a connector. The product cutting system is used to cut the connector terminals 31 and the material strip 32 connected to the connector terminals 31. The material strip 32 is used to position and convey the connector terminals 31. However, the present invention is not limited to the illustrated embodiments, and the product cutting system can also be used to cut other products.

According to the present invention, the same cutting device 1 can cut different products 3, expanding the application range of the product cutting system.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A product cutting system, comprising:
a cutting device disposed at a cutting station for cutting a product; and
a conveying device transporting the product to be cut to the cutting station, the cutting device is separate from the conveying device and can cooperate with a plurality of different conveying devices to cut a plurality of different products.

2. The product cutting system according to claim 1, wherein the cutting device includes:
an installation frame;
a pair of cutting dies installed on the installation frame and capable of being opened and closed in a vertical direction to cut the product; and
a first driving device installed on the installation frame to drive the pair of cutting dies to open and close.

3. The product cutting system according to claim 2, wherein the conveying device includes a conveying channel guiding the product along a predetermined path to the cutting station, the conveying channel is separable from the installation frame so that different products can be transported to the cutting station by replacing the conveying channel.

4. The product cutting system according to claim 3, wherein the pair of cutting dies includes a lower cutting die fixed on the installation frame and an upper cutting die movably installed on the installation frame, the conveying channel has a matching notch that matches with the lower cutting die, the lower cutting die is matched into the matching notch of the conveying channel so that the product can be transported to the lower cutting die.

5. The product cutting system according to claim 4, wherein the first driving device is connected to the upper cutting die and drives the upper cutting die to move in the vertical direction to cut the product at the lower cutting die.

6. The product cutting system according to claim 5, further comprising a first control device controlling an output force and an output speed of the first driving device to ensure that the upper cutting die can cut the product with a predetermined cutting force and a predetermined cutting speed.

7. The product cutting system according to claim 4, wherein a slot hole is formed in and vertically passes though the lower cutting die, the upper cutting die has a protrusion suitable for matching with the slot hole, a plurality of edges of the slot hole and the protrusion form cutting edges for cutting the product.

8. The product cutting system according to claim 7, wherein, when a portion to be cut of the product is moved and positioned into the slot hole of the lower cutting die, the protrusion of the upper cutting die is inserted into the slot hole of the lower cutting die to cut the portion to be cut of the product.

9. The product cutting system according to claim 8, further comprising:
a waste channel, an inlet of the waste channel is connected to an outlet of the slot hole of the lower cutting die to receive waste generated during cutting the product; and
a waste recycling bin connected to the outlet of the waste channel to receive waste discharged from the waste channel, the waste channel and the waste recycling box are fixed to the installation frame.

10. The product cutting system according to claim 9, wherein the installation frame includes:
a support body extending to a predetermined height in the vertical direction;
a top plate fixed to a top of the support body;
a bottom plate fixed to a bottom of the support body; and
a support plate fixed to a top surface of the bottom plate, the first driving device is installed on the top plate, the upper cutting die is movably installed on the support body, the lower cutting die is fixed to the support plate, the waste channel and the waste recycling box are respectively fixed to the support plate and the bottom plate.

11. The product cutting system according to claim 2, further comprising a base supporting the installation frame, the installation frame is movably installed on the base and can be moved along a first horizontal direction, the conveying device transports the product along a second horizontal direction perpendicular to the first horizontal direction.

12. The product cutting system according to claim 11, further comprising a guide rail fixed on the base and extending along the first horizontal direction and a slider slidably installed on the guide rail to slide along the guide rail, a bottom of the installation frame is connected to the slider to move along the guide rail together with the slider.

13. The product cutting system according to claim 12, further comprising a second driving device installed on the base and driving the installation frame to move along the first horizontal direction, to move the pair of cutting dies to a predetermined cutting position.

14. The product cutting system according to claim 13, wherein the second driving device includes:
a lead screw having a pair of ends rotatably installed on the base;
a nut threaded to the lead screw;
a driving block fixed to the nut; and
a servo motor installed on the base, an axis of the lead screw extends along the first horizontal direction and the servo motor is connected to one of the ends of the lead screw to drive the lead screw to rotate around the axis, the driving block is connected to the bottom of the installation frame, and when the lead screw is rotated, the nut and the driving block are moved together along the axis of the lead screw to drive the installation frame to move along the first horizontal direction.

15. The product cutting system according to claim 14, further comprising a second control device controlling the second driving device and a position sensor installed on the base to detect a position of the pair of cutting dies, the second control device controls the second driving device based on a position detected by the position sensor to move the pair of cutting dies to the predetermined cutting position.

16. The product cutting system according to claim 15, wherein the position sensor is a trigger switch that is triggered when the pair of cutting dies are moved to the predetermined cutting position.

17. The product cutting system according to claim 16, wherein the product cutting system has a plurality of position sensors that are spaced in the first horizontal direction and correspond to a plurality of predetermined cutting positions.

18. The product cutting system according to claim 16, further comprising a triggering member fixed to the bottom of the installation frame to move together with the installation frame, and when the pair of cutting dies are moved to the predetermined cutting position, the triggering member is moved to a predetermined triggering position and triggers one of the position sensors.

19. The product cutting system according to claim 16, further comprising:
a sliding slot member fixed to the base and having a sliding slot extending along the first horizontal direction; and
a connecting member slidably installed in the sliding slot of the sliding slot member and connected to the position sensor, the position sensor can be moved along the sliding slot with the connecting member, so that the position of the position sensor can be adjusted to be suitable for different products to be cut.

20. The product cutting system according to claim 19, wherein the base includes:
a base plate;
a strip body fixed on a top surface of the base plate;
an end plate fixed to an end of the base plate; and
a pair of support blocks fixed on the top surface of the base plate, the servo motor is fixed to the end plate, the pair of ends of the lead screw are respectively rotatably installed on the pair of support blocks, the guide rail is fixed to a top surface of the strip body and the sliding slot member is fixed to a side surface of the strip body.
